(19) United States
(12) Patent Application Publication
(10) Pub. No.: US 2026/0108983 A1
(43) Pub. Date: Apr. 23, 2026

(54) LASER IRRADIATION POSITIONING SYSTEM AND LASER IRRADIATION POSITIONING METHOD FOR WELDING SECONDARY BATTERY

(71) Applicant: SK On Co., Ltd., Seoul (KR)

(72) Inventors: Seung Won LEE, Daejeon (KR); Hyo Sung HONG, Daejeon (KR); Jae Hun KIM, Daejeon (KR); Hyeong Won KIM, Daejeon (KR)

(21) Appl. No.: 19/332,067

(22) Filed: Sep. 18, 2025

(30) Foreign Application Priority Data
Oct. 23, 2024 (KR) 10-2024-0145770

(51) Int. Cl. B23K 26/08

(52) U.S. Cl. CPC B23K 26/0876

(57) ABSTRACT

The present disclosure relates to a laser irradiation positioning system for welding secondary battery components. Such a laser irradiation positioning system for welding secondary battery components is configured to calculate a position at which a laser is to be irradiated so as to significantly improve the welding strength between the secondary battery components when the laser is irradiated for welding, thereby enabling a significant improvement in the welding strength between the secondary battery components.

### CROSS-REFERENCE TO RELATED PATENT APPLICATION

The present application claims priority under 35 U.S.C. § 119 (a) to Korean patent application number 10-2024-0145770 filed on Oct. 23, 2024, in the Korean Intellectual Property Office, the entire disclosure of which is incorporated by reference herein.

### BACKGROUND OF THE INVENTION

### 1. Field

Embodiments of the present disclosure relate to a laser irradiation positioning system and a laser irradiation positioning method for welding secondary battery components, and more particularly, to a laser irradiation positioning system and a laser irradiation positioning method for welding secondary battery components, which can improve the welding strength between the secondary battery components.

### 2. Description of the Related Art

Among the processes performed in the manufacturing of a secondary battery, the welding process is gradually increasing in importance, and the higher the welding strength between the secondary battery components welded by the welding process, the greater the improvement in durability and performance of the secondary battery.

In order to weld secondary battery components to each other, a filler metal may be disposed in a gap between adjacent secondary battery components, and a laser may be irradiated onto the filler metal. The welding strength between the secondary battery components may vary depending on the position at which the laser is irradiated through the gap.

Therefore, in order to calculate a laser irradiation position that can maximize the welding strength between the secondary battery components, it is necessary to first calculate the positions of the secondary battery components to be welded to each other, and then calculate an optimal position at which the laser is to be irradiated among the positions of the gap between the secondary battery components, the gap being derived based on the calculated positions of the secondary battery components.

In order to calculate a position that can improve the welding strength as described above, a conventional Auto-Position-Alignment (APA) system has been used. However, the conventional APA system has a problem in that it fails to accurately calculate the positions of the secondary battery components to be welded, which must be calculated in advance in order to calculate the optimal position at which the laser is to be irradiated.

In addition, even if the conventional APA system accurately recognizes the positions of the secondary battery components to be welded and accurately derives the position of the gap, it has a problem in that it fails to accurately calculate the position within the gap at which the laser is to be irradiated to maximize the welding strength.

Therefore, it is necessary to develop a laser irradiation positioning system for welding secondary battery components in order to solve these problems.

### SUMMARY OF THE INVENTION

An object of the present disclosure is to calculate the accurate positions of secondary battery components to be welded to each other.

Another object of the present disclosure is to allow a laser to be irradiated through a gap so that the welding strength between secondary battery components is significantly improved.

Another object of the present disclosure is to improve the durability and performance of the secondary battery.

The laser irradiation positioning system and laser irradiation positioning method for welding secondary battery components according to the present disclosure can be widely applied in green technology fields that use batteries, such as electric vehicles. In addition, the laser irradiation positioning system and laser irradiation positioning method for welding secondary battery components according to the present disclosure can be used in the manufacture of batteries used in eco-friendly electric vehicles, hybrid vehicles, and the like, which suppress air pollution and greenhouse gas emissions to prevent climate change.

Meanwhile, the present disclosure can be widely applied in green technology fields such as electric vehicles (EVs), battery charging stations, energy storage systems (ESS), and other battery-based technologies including photovoltaics and wind power. In addition, the present disclosure can be used in eco-friendly mobility, including electric vehicles and hybrid vehicles, which suppress air pollution and greenhouse gas emissions to prevent climate change.

As a technical means to achieve the technical objects, a laser irradiation positioning system for welding secondary battery components according to an embodiment of the present disclosure may comprise: an imaging portion configured to record a video of a secondary battery including a first component and a second component to be welded to each other, and acquire image data; an identification portion configured to receive the image data and identify first image data relating to a video of the first component and second image data relating to a video of the second component from the image data; a conversion portion configured to generate a virtual coordinate plane including a first axis and a second axis, convert the first image data into a plurality of first coordinates arranged on the virtual coordinate plane, and convert the second image data into a plurality of second coordinates arranged on the virtual coordinate plane; and a calculation portion configured to calculate a position at which a laser is to be irradiated based on the plurality of first coordinates and the plurality of second coordinates.

In addition, the identification portion may be configured to identify the first image data and the second image data by learning image data relating to components of the secondary battery including the first component and the second component.

In addition, the calculation portion may be configured to:
move the first axis and the second axis such that an average value of values corresponding to the first axis among the plurality of first coordinates is located at an origin with respect to the first axis, and an average value of values corresponding to the second axis among the plurality of first coordinates is located at an origin with respect to the second axis,
thereby converting the plurality of first coordinates into a plurality of first shifted coordinates and converting the plurality of second coordinates into a plurality of second shifted coordinates;
calculate positions of a first reference coordinate among the plurality of first shifted coordinates and a second reference coordinate among the plurality of second shifted coordinates, the first reference coordinate being a coordinate that intersects with a virtual line extending from the origin and forming a predetermined angle with the first axis, and the second reference coordinate being a coordinate that intersects with the virtual line; and
calculate a third coordinate, at which a laser is to be irradiated, the third coordinate being located between the first reference coordinate and the second reference coordinate.

In addition, the predetermined angle may be an angle selected in a range of 0 degrees to 360 degrees.

In addition, the third coordinate may be located at a position spaced by a predetermined distance from the first reference coordinate toward the second reference coordinate.

In addition, the predetermined distance may be a distance corresponding to a predetermined ratio of a distance between the first reference coordinate and the second reference coordinate.

In addition, the predetermined ratio may be in a range of 0.2 to 0.7.

In addition, the position of the first reference coordinate may be calculated by the following Equation 1, and the position of the second reference coordinate may be calculated by the following Equation 2.

$${P}_{1} = ( {L}_{1} * cos θ , {L}_{1} * sin θ ) \qquad [ Equation 1 ]$$

(where P₁ refers to the position of the first reference coordinate, L₁ refers to the distance between the first reference coordinate and the origin, and θ refers to a predetermined angle formed between the first axis and the virtual line segment)

$${P}_{2} = ( {L}_{2} * cos θ , {L}_{2} * sin θ ) \qquad [ Equation 2 ]$$

(where P₂ denotes the position of the second reference coordinate, L₂ denotes the distance between the second reference coordinate and the origin, and θ denotes a predetermined angle formed between the first axis and the virtual line)

In addition, the position of the third coordinate may be calculated by the following Equation 3.

$${P}_{3} = ( {L}_{1} * cos θ + ( {L}_{2} * cos θ - {L}_{1} * cos θ ) * R , {L}_{1} * sin θ + ( {L}_{2} * sin θ - {L}_{1} * sin θ ) * R ) \qquad [ Equation 3 ]$$

(where P₃ is the third coordinate, L₁ is the distance between the first reference coordinate and the origin, L₂ is the distance between the second reference coordinate and the origin, θ is the angle formed between the first axis and the virtual line, and R is a predetermined ratio of the distance between the first reference coordinate and the second reference coordinate)

In addition, the predetermined ratio may be 0.5.

As a technical means to achieve the technical objects, a laser irradiation positioning method for welding secondary battery components according to an embodiment of the present disclosure may comprise: an imaging step of recording a video of a secondary battery including a first component and a second component to be welded to each other, and acquiring image data; an identification step of receiving the image data and identifying first image data relating to a video of the first component and second image data relating to a video of the second component from the image data; a conversion step of generating a virtual coordinate plane including a first axis and a second axis, converting the first image data into a plurality of first coordinates arranged on the virtual coordinate plane, and converting the second image data into a plurality of second coordinates arranged on the virtual coordinate plane; and a calculation step of calculating a position at which a laser is to be irradiated based on the plurality of first coordinates and the plurality of second coordinates.

In addition, the calculation step may comprise: a placement step of moving the first axis and the second axis such that an average value of values corresponding to the first axis among the plurality of first coordinates is located at an origin with respect to the first axis, and an average value of values corresponding to the second axis among the plurality of first coordinates is located at an origin with respect to the second axis, thereby converting the plurality of first coordinates into a plurality of first shifted coordinates and converting the plurality of second coordinates into a plurality of second shifted coordinates; a first calculation step of calculating positions of a first reference coordinate among the plurality of first shifted coordinates and a second reference coordinate among the plurality of second shifted coordinates, the first reference coordinate being a coordinate that intersects with a virtual line extending from the origin and forming a predetermined angle with the first axis, and the second reference coordinate being a coordinate that intersects with the virtual line; and a second calculation step of calculating a third coordinate, at which a laser is to be irradiated, the third coordinate being located between the first reference coordinate and the second reference coordinate.

In addition, the predetermined angle may be an angle selected in a range of 0 degrees to 360 degrees.

In addition, the third coordinate may be located at a position spaced by a predetermined distance from the first reference coordinate toward the second reference coordinate.

In addition, the predetermined distance may be a distance corresponding to a predetermined ratio of a distance between the first reference coordinate and the second reference coordinate.

In addition, the position of the first reference coordinate may be calculated by the following Equation 1, and the position of the second reference coordinate may be calculated by the following Equation 2.

$${P}_{1} = ( {L}_{1} * cos θ , {L}_{1} * sin θ ) \qquad [ Equation 1 ]$$

(where P₁ refers to the position of the first reference coordinate, L₁ refers to the distance between the first reference coordinate and the origin, and θ refers to a predetermined angle formed between the first axis and the virtual line segment)

$${P}_{2} = ( {L}_{2} * cos θ , {L}_{2} * sin θ ) \qquad [ Equation 2 ]$$

(where P₂ denotes the position of the second reference coordinate, L₂ denotes the distance between the second reference coordinate and the origin, and θ denotes a predetermined angle formed between the first axis and the virtual line)

In addition, the position of the third coordinate may be calculated by the following Equation 3.

$${P}_{3} = ( {L}_{1} * cos θ + ( {L}_{2} * cos θ - {L}_{1} * cos θ ) * R , {L}_{1} * sin θ + ( {L}_{2} * sin θ - {L}_{1} * sin θ ) * R ) \qquad [ Equation 3 ]$$

(where P₃ is the third coordinate, L₁ is the distance between the first reference coordinate and the origin, L₂ is the distance between the second reference coordinate and the origin, θ is the angle formed between the first axis and the virtual line, and R is a predetermined ratio of the distance between the first reference coordinate and the second reference coordinate)

In addition, the predetermined ratio may be in a range of 0.2 to 0.7.

Specific details of other embodiments for solving the above-described problems are included in the description of the invention and the drawings.

According to an embodiment of the present disclosure described above, the laser irradiation positioning system and the laser irradiation positioning method for welding secondary battery components according to the present disclosure are configured such that artificial intelligence trained on image data relating to secondary battery components identifies image data of secondary battery components to be welded to each other, thereby providing an effect of enabling accurate calculation of the positions of the secondary battery components to be welded to each other.

In addition, since the system is configured to calculate a position within the gap at which a laser is to be irradiated, based on the accurately calculated positions of the secondary battery components, so as to significantly improve the welding strength between the secondary battery components, it provides an effect of enabling the laser to be irradiated through the gap and significantly improving the welding strength between the secondary battery components.

In addition, since the welding strength between the secondary battery components can be significantly improved, it provides an effect of improving the durability and performance of the secondary battery.

### BRIEF DESCRIPTION OF THE DRAWINGS

FIG. 1 illustrates a first component and a second component to be welded to each other, and a filler metal disposed between the first component and the second component, to which a laser is irradiated.

FIG. 2 illustrates a welding position where the positions of a first component and a second component to be welded to each other are not taken into consideration.

FIG. 3 is a block diagram illustrating a laser irradiation positioning system for welding secondary battery components according to an embodiment of the present disclosure.

FIG. 4 illustrates a plurality of first coordinates and a plurality of second coordinates arranged on a virtual coordinate plane.

FIG. 5 illustrates a plurality of first shifted coordinates and a plurality of second shifted coordinates arranged on a virtual coordinate plane in which coordinate axes have been moved.

FIG. 6 illustrates a first reference coordinate, among a plurality of first shifted coordinates, intersecting with a virtual line, and a second reference coordinate, among a plurality of second shifted coordinates, intersecting with the virtual line.

FIG. 7 illustrates a third coordinate on the virtual coordinate plane.

FIG. 8 is a graph showing internal pressure with respect to a distance by which a third coordinate is spaced from a first reference coordinate toward a second reference coordinate.

FIG. 9 is a flowchart illustrating a laser irradiation positioning method for welding secondary battery components according to an embodiment of the present disclosure.

FIG. 10 is a flowchart illustrating the calculation step.

### DETAILED DESCRIPTION

Hereinafter, embodiments of the present disclosure will be described in detail with reference to the accompanying drawings so that those skilled in the art to which the present disclosure pertains can easily implement the disclosure. However, the present disclosure may be implemented in various different forms and is not limited to the embodiments described herein. In addition, parts irrelevant to the description have been omitted in order to clearly describe the present disclosure, and similar reference numerals are used for similar elements throughout the specification.

Throughout the present specification, when a certain part is described as being “connected” to another part, this includes not only cases where the parts are “directly connected” to each other, but also cases where they are “electrically connected” with another element interposed therebetween.

Throughout the present specification, when a certain member is described as being “on” another member, this includes not only cases where the member is in contact with the other member, but also cases where another member is interposed between the two members.

Throughout the present specification, when a certain part is described as “including” a certain component, this does not exclude the presence of other components unless expressly stated otherwise, and may include additional components. Terms indicating degrees, such as “about” and “substantially,” as used throughout the present specification, are intended to mean values close to the numerical values when considering inherent manufacturing and material tolerances, and are also used to prevent unscrupulous infringers from unfairly exploiting the disclosure by strictly interpreting the numerical values mentioned solely for the purpose of understanding the invention. The expressions such as “a step of ˜” or “the step of ˜,” as used throughout the present specification, do not imply “a step for ˜.”

Hereinafter, preferred embodiments of the present disclosure will be described in detail with reference to the accompanying drawings and the following description. However, the present disclosure is not limited to the embodiments described herein and may be embodied in other forms. Throughout the specification, like reference numerals refer to like elements.

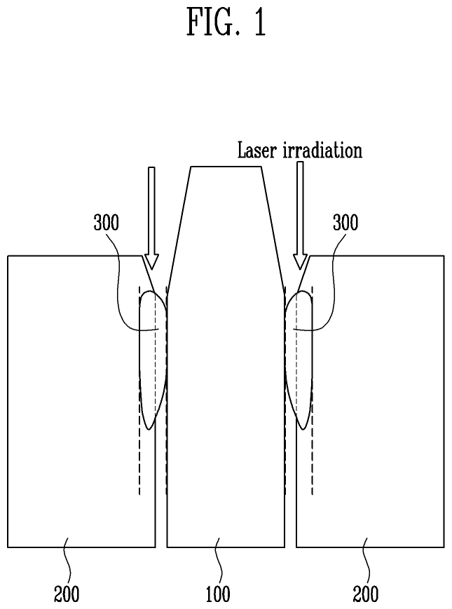

FIG. 1 illustrates a first component and a second component to be welded to each other, and a filler metal disposed between the first component and the second component, to which a laser is irradiated.

Referring to FIG. 1, a first component 100 and a second component 200 of a secondary battery may be welded to each other by placing a filler material 300 in a gap between the first component 100 and the second component 200, and irradiating the filler material 300 with a laser.

In this case, the gap surrounding the outer circumferential surface of the first component 100 may have a ring shape, but depending on the relative positions of the first component 100 and the second component 200, the width of the gap in the direction from the first component 100 toward the second component 200 may not be uniform.

Therefore, in order to weld the secondary battery components to each other, it is necessary to accurately identify the positions of the first component 100 and the second component 200, and to irradiate a laser onto the identified gap based on the identified positions of the first component 100 and the second component 200.

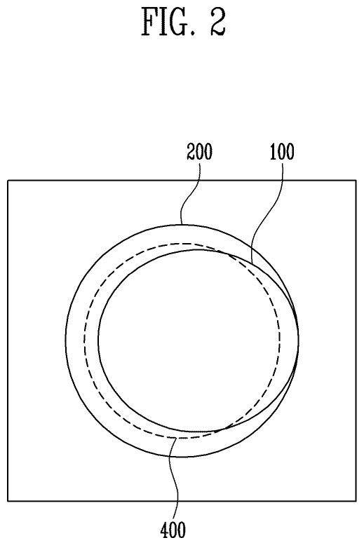

FIG. 2 illustrates a welding position where the positions of a first component and a second component to be welded to each other are not taken into consideration.

For example, referring to FIG. 2, a portion of the outer circumferential surface of the first component 100 may be positioned relatively close to the inner circumferential surface of the second component 200, while another portion of the outer circumferential surface of the first component 100 may be positioned relatively far from the inner circumferential surface of the second component 200.

In such a case, as shown in FIG. 2, if a laser is irradiated at a predetermined welding position 400, the laser may be directed toward the gap, but it may also be irradiated at a location where no gap is formed.

As described above, in order to weld the components of a secondary battery to each other, a laser must be irradiated through the gap between the components. Therefore, as shown in FIG. 2, if the laser is irradiated only at a predetermined welding position 400 without considering the positions of the first component 100 and the second component 200, the welding strength between the first component 100 and the second component 200 may be reduced.

Meanwhile, even if the positions of the first component 100 and the second component 200 are identified and a laser is irradiated through a gap formed between the first component 100 and the second component 200 based on the identified positions, the location of the gap may not be accurately determined if the positions of the first component 100 and the second component 200 are not precisely identified.

Therefore, in such a case, the laser may be irradiated to a location where no gap is formed, which may result in a decrease in the welding strength between the first component 100 and the second component 200.

A laser irradiation positioning system for welding secondary battery components according to an embodiment of the present disclosure has been devised to solve these problems. Hereinafter, the configuration of the laser irradiation positioning system for welding secondary battery components according to an embodiment of the present disclosure will be described.

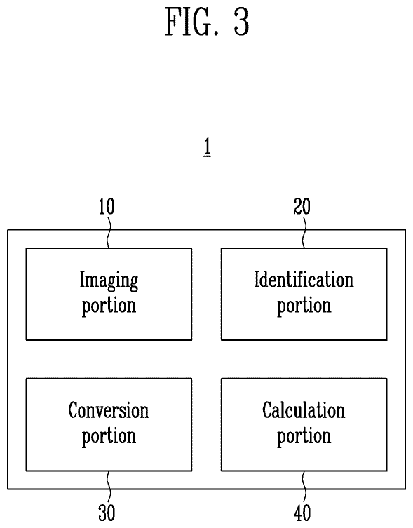

FIG. 3 is a block diagram illustrating a laser irradiation positioning system for welding secondary battery components according to an embodiment of the present disclosure.

Referring to FIG. 3, the laser irradiation positioning system 1 for welding secondary battery components includes an imaging portion 10, an identification portion 20, a conversion portion 30, and a calculation portion 40.

First, the imaging portion 10 will be described.

The imaging portion is configured to video the secondary battery including the first component and the second component to be welded to each other, and acquire image data.

The imaging portion 10 may be configured as a video imaging apparatus including a camera or the like capable of acquiring image data of a predetermined object, but the configuration of the imaging portion 10 is not limited thereto.

Next, the identification portion 20 will be described.

The identification portion 20 is configured to receive the image data acquired by the imaging portion 10 and identify first image data relating to a video of the first component 100 and second image data relating to a video of the second component 200 from the image data.

The identification portion 20 may be configured to include a computer system. For example, the identification portion 20 may be configured to include artificial intelligence (AI) and be configured to identify the first image data and the second image data using the artificial intelligence.

Meanwhile, the artificial intelligence included in the identification portion 20 may be configured to perform machine learning. Specifically, the artificial intelligence included in the identification portion 20 may be configured to identify the first image data and the second image data by learning image data related to components of the secondary battery including the first component 100 and the second component 200.

As such, when the identification portion 20 is configured to identify the first image data and the second image data using artificial intelligence that has learned image data related to secondary battery components, the positions of the first component 100 and the second component 200 to be welded to each other can be identified more accurately.

Next, the conversion portion 30 will be described.

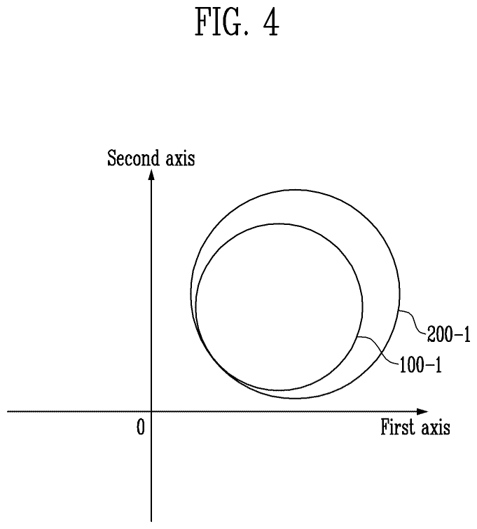

FIG. 4 illustrates a plurality of first coordinates and a plurality of second coordinates arranged on a virtual coordinate plane.

As illustrated in FIG. 4, the conversion portion 30 is configured to generate a virtual coordinate plane including a first axis and a second axis, convert the first image data into a plurality of first coordinates 100-1 arranged on the virtual coordinate plane, and convert the second image data into a plurality of second coordinates 200-1 arranged on the virtual coordinate plane.

The conversion portion 30 may be configured as a device including a computer capable of converting image data into coordinates; however, the configuration of the conversion portion 30 is not limited thereto.

Meanwhile, the conversion portion 30 may use fast Fourier transform (FFT) when converting the first image data into the plurality of first coordinates 100-1 or converting the second image data into the plurality of second coordinates 200-1.

As such, when a fast Fourier transform is used to convert image data into coordinates, the conversion portion 30 may enable the image data of the first component 100 and the second component 200, videoed by the imaging portion 10, to be more accurately converted into coordinates.

Next, the calculation portion 40 will be described.

The calculation portion 40 may calculate a position at which a laser is to be irradiated based on the plurality of first coordinates 100-1 and the plurality of second coordinates 200-1.

The calculation portion 40 may be configured as a device including a computer capable of performing operations on coordinate data, but the configuration of the calculation portion 40 is not limited thereto.

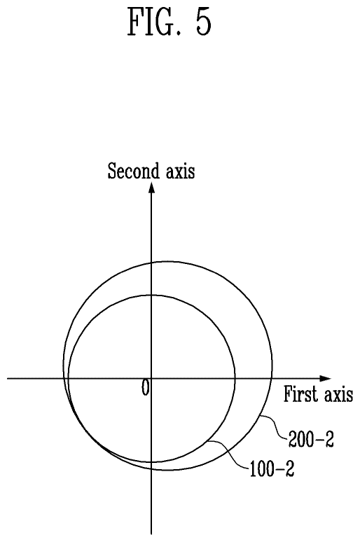

FIG. 5 illustrates a plurality of first shifted coordinates and a plurality of second shifted coordinates arranged on a virtual coordinate plane in which coordinate axes have been moved.

Specifically, as illustrated in FIGS. 4 and 5, the calculation portion 40 may move the first axis and the second axis such that an average value of values corresponding to the first axis among the plurality of first coordinates 100-1 is located at the origin of the first axis, and an average value of values corresponding to the second axis among the plurality of first coordinates 100-1 is located at the origin of the second axis. Accordingly, the plurality of first coordinates 100-1 may be converted into a plurality of first shifted coordinates 100-2, and the plurality of second coordinates 200-1 may be converted into a plurality of second shifted coordinates 200-2.

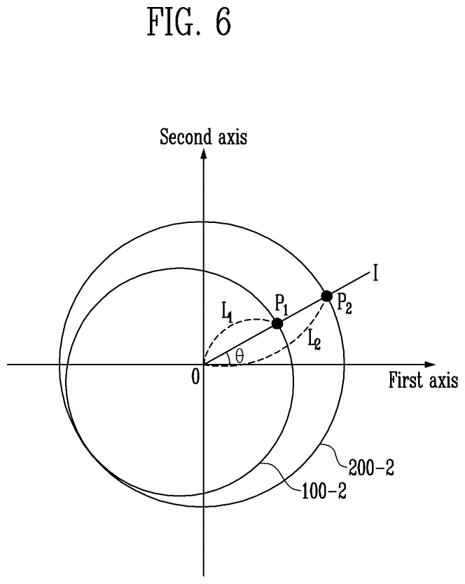

FIG. 6 illustrates a first reference coordinate, among a plurality of first shifted coordinates, intersecting with a virtual line, and a second reference coordinate, among a plurality of second shifted coordinates, intersecting with the virtual line.

And, as illustrated in FIG. 6, the calculation portion 40 may calculate a position of a first reference coordinate P₁, which is one of the plurality of first shifted coordinates 100-2 that intersects with a virtual line I extending from the origin and forming a predetermined angle θ with the first axis.

In this case, the predetermined angle θ formed between the virtual line I and the first axis may be equal to or greater than 0 degrees and equal to or less than 360 degrees.

For example, the calculation portion 40 may calculate a position of the first reference coordinate P1 according to the following Equation 1.

$${P}_{1} = ( {L}_{1} * cos θ , {L}_{1} * sin θ )$$

(where P₁ refers to the position of the first reference coordinate, L₁ refers to the distance between the first reference coordinate and the origin, and θ refers to a predetermined angle formed between the first axis and the virtual line segment)

Meanwhile, the calculation portion 40 may also calculate the position of second reference coordinate P₂ among the plurality of second shifted coordinates 200-2, the second reference coordinate P₂ being a coordinate that intersects with a virtual line segment I extending from the origin and forming a predetermined angle θ with the first axis.

For example, the calculation portion 40 may calculate the position of second reference coordinate P₂ according to the following Equation 2.

$${P}_{2} = ( {L}_{2} * cos θ , {L}_{2} * sin θ )$$

(where P₂ denotes the position of the second reference coordinate, L₂ denotes the distance between the second reference coordinate and the origin, and θ denotes a predetermined angle formed between the first axis and the virtual line) As such, after calculating the first reference coordinate P₁ and the second reference

coordinate P₂, the calculation portion 40 may calculate a third coordinate P₃, at which a laser is to be irradiated, the third coordinate being located between the first reference coordinate P₁ and the second reference coordinate P₂.

The third coordinate P₃ may be located at a predetermined distance from the first reference coordinate P₁ toward the second reference coordinate P₂, and the predetermined distance may correspond to a predetermined ratio of the distance between the first reference coordinate P₁ and the second reference coordinate P₂.

For example, the calculation portion 40 may calculate a position of the third coordinate P₃ according to the following Equation 3.

$${P}_{3} = ( {L}_{1} * cos θ + ( {L}_{2} * cos θ - {L}_{1} * cos θ ) * R , {L}_{1} * sin θ + ( {L}_{2} * sin θ - {L}_{1} * sin θ ) * R )$$

(where P₃ is the third coordinate, L₁ is the distance between the first reference coordinate and the origin, L₂ is the distance between the second reference coordinate and the origin, θ is the angle formed between the first axis and the virtual line, and R is a predetermined ratio of the distance between the first reference coordinate and the second reference coordinate)

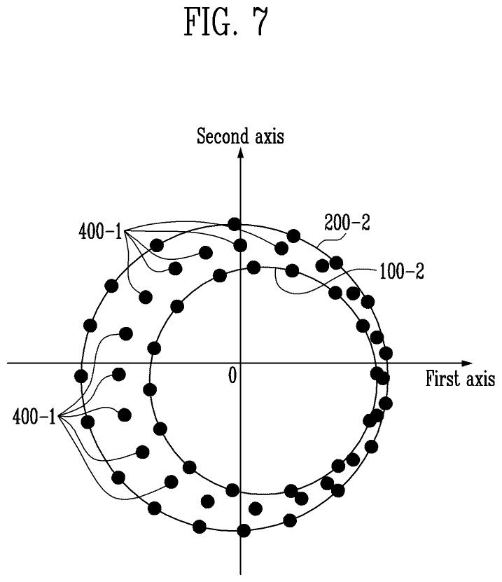

FIG. 7 illustrates a third coordinate on the virtual coordinate plane.

As described above, the third coordinate P₃, the position of which is calculated as described, is located between the first shifted coordinates 100-2 and the second shifted coordinates 200-2, as illustrated in FIG. 7.

Meanwhile, the third coordinate P₃ may have its position calculated such that the welding strength between the first component 100 and the second component 200 is significantly improved.

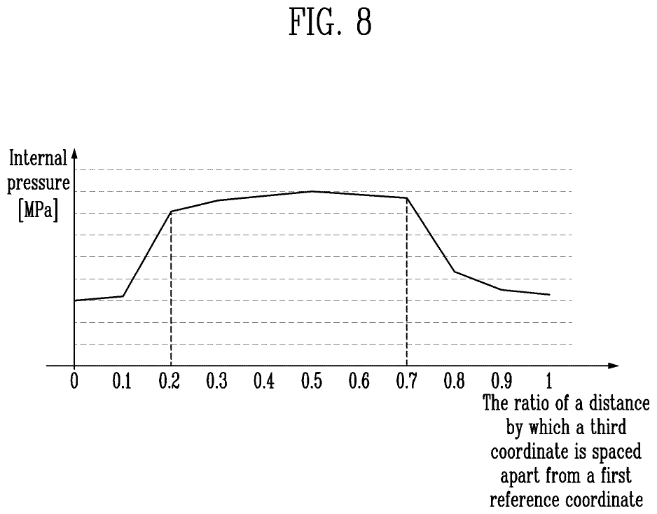

FIG. 8 is a graph showing internal pressure with respect to a distance by which a third coordinate is spaced from a first reference coordinate toward a second reference coordinate.

Referring to FIG. 8, it can be seen that when the third coordinate P₃ is spaced apart from the first reference coordinate P₁ toward the second reference coordinate P₂ by a predetermined distance, and a ratio of the predetermined distance to a distance between the first reference coordinate P₁ and the second reference coordinate P₂ is 0.2 or more and 0.7 or less, the internal pressure resistance is significantly increased.

That is, when the predetermined ratio is 0.2 or more and 0.7 or less, the internal pressure resistance can be significantly increased.

At this time, the internal pressure resistance refers to the force required to separate the first component and the second component that are welded to each other.

Therefore, the calculation portion 40 may calculate the position of the third coordinate P₃ such that the third coordinate P₃ is located at a distance spaced apart from the first reference coordinate P₁ toward the second reference coordinate P₂ by an amount of 0.2 to 0.7 times the distance between the first reference coordinate P₁ and the second reference coordinate P₂, so that when a laser is irradiated toward the third coordinate P₃, the welding strength between the first component 100 and the second component 200 is significantly improved.

In addition, since the internal pressure resistance is maximized when the ratio of the predetermined distance by which the third coordinate P₃ is spaced apart from the first reference coordinate P₁ toward the second reference coordinate P₂ to the distance between the first reference coordinate P₁ and the second reference coordinate P₂ is 0.5, the calculation portion 40 may calculate the position of the third coordinate P₃ such that the third coordinate P₃ is located at a distance spaced apart from the first reference coordinate P₁ toward the second reference coordinate P₂ by 0.5 times the distance between the first reference coordinate P₁ and the second reference coordinate P₂.

That is, when the predetermined ratio is 0.5, the internal pressure resistance can be maximized.

Hereinafter, a laser irradiation positioning method for welding secondary battery components according to an embodiment of the present disclosure will be described.

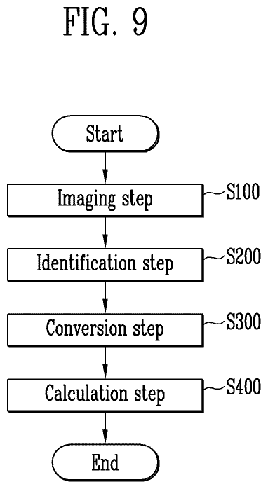

FIG. 9 is a flowchart illustrating a laser irradiation positioning method for welding secondary battery components according to an embodiment of the present disclosure.

Referring to FIG. 9, the laser irradiation positioning method for welding secondary battery components may comprise an imaging step S100, an identification step S200, a conversion step S300, and a calculation step S400.

First, the imaging step S100 will be described.

The imaging step S100 is a step of recording a video of a secondary battery including a first component and a second component to be welded to each other and acquiring image data.

In the imaging step S100, an imaging portion including a camera or the like capable of acquiring image data of a predetermined object may be used.

Next, the identification step S200 will be described.

The identification step S200 is a step of receiving the image data acquired in the imaging step S100 and identifying first image data relating to a video of the first component and second image data relating to a video of the second component from the image data.

In the identification step S200, a computer system may be used to identify the first image data and the second image data, and artificial intelligence (AI) may also be used to identify the first image data and the second image data.

Meanwhile, the artificial intelligence used in the identification step S200 may be configured to perform machine learning. Specifically, the artificial intelligence may be configured to identify the first image data and the second image data by learning image data related to components of the secondary battery including the first component and the second component.

As such, when the identification step S200 uses artificial intelligence trained on image data related to secondary battery components to identify the first image data and the second image data, the positions of the first component and the second component to be welded to each other can be identified more accurately.

Next, the conversion step S300 will be described.

The conversion step S300 is a step of generating a virtual coordinate plane including a first axis and a second axis, converting the first image data into a plurality of first coordinates arranged on the virtual coordinate plane, and converting the second image data into a plurality of second coordinates arranged on the virtual coordinate plane.

In the conversion step S300, a fast Fourier transform may be used when converting the first image data into a plurality of first coordinates or converting the second image data into a plurality of second coordinates.

As such, when a fast Fourier transform is used to convert image data into coordinates, the conversion step S300 can enable the image data of the first component and the second component captured in the imaging step S100 to be converted into coordinates more accurately.

Next, the calculation step S400 will be described.

The calculation step S400 is a step of calculating a position at which a laser is to be irradiated based on the plurality of first coordinates and the plurality of second coordinates.

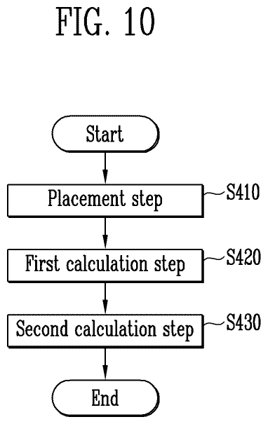

FIG. 10 is a flowchart illustrating the calculation step.

As illustrated in FIG. 10, the calculation step S400 may include a placement step S410, a first calculation step S420, and a second calculation step S430.

The placement step S410 is a step of moving the first axis and the second axis such that an average value of values corresponding to the first axis among the plurality of first coordinates is located at the origin of the first axis, and an average value of values corresponding to the second axis among the plurality of first coordinates is located at the origin of the second axis, thereby converting the plurality of first coordinates into a plurality of first shifted coordinates and converting the plurality of second coordinates into a plurality of second shifted coordinates.

The first shifted coordinates and the second shifted coordinates arranged on the virtual coordinate plane by the calculation step S400 may be arranged as illustrated in FIG. 5.

The first calculation step S420 is a step of calculating a position of a first reference coordinate P₁, which is one of the plurality of first shifted coordinates that intersects with a virtual line extending from the origin and forming a predetermined angle with the first axis, and a position of a second reference coordinate P₂, which is one of the plurality of second shifted coordinates that intersects with the virtual line.

Specifically, as illustrated in FIG. 6, the first calculation step S420 may calculate a position of a first reference coordinate P₁, which is one of the plurality of first shifted coordinates that intersects with a virtual line segment I extending from the origin and forming a predetermined angle θ with the first axis.

In this case, the predetermined angle θ formed between the virtual line segment I and the first axis may be equal to or greater than 0 degrees and equal to or less than 360 degrees.

For example, in the first calculation step S420, the position of the first reference coordinate P₁ may be calculated according to the following Equation 1.

$${P}_{1} = ( {L}_{1} * cos θ , {L}_{1} * sin θ )$$

(where P₁ is the position of the first reference coordinate, L₁ is the distance between the first reference coordinate and the origin, and θ is a predetermined angle formed between the first axis and the virtual line segment)

Meanwhile, in the first calculation step S420, the position of a second reference coordinate P₂, which is one of the plurality of second shifted coordinates that intersects with a virtual line segment I extending from the origin and forming a predetermined angle θ with the first axis, may also be calculated.

For example, in the first calculation step S420, the position of the second reference coordinate P₂ may be calculated according to the following Equation 2.

$${P}_{2} = ( {L}_{2} * cos θ , {L}_{2} * sin θ )$$

(where P₂ is the position of the second reference coordinate, L₂ is the distance between the second reference coordinate and the origin, and θ is a predetermined angle formed between the first axis and the virtual line segment)

The second calculation step S430 is a step of calculating a third coordinate, at which a laser is to be irradiated, the third coordinate being located between the first reference coordinate and the second reference coordinate.

The third coordinate P₃ may be located at a predetermined distance spaced apart from the first reference coordinate P₁ toward the second reference coordinate P₂, and the predetermined distance may correspond to a predetermined ratio of the distance between the first reference coordinate P₁ and the second reference coordinate P₂.

For example, in the second calculation step S430, the position of the third coordinate P₃ may be calculated according to the following Equation 3.

$${P}_{3} = ( {L}_{1} * cos θ + ( {L}_{2} * cos θ - {L}_{1} * cos θ ) * R , {L}_{1} * sin θ + ( {L}_{2} * sin θ - {L}_{1} * sin θ ) * R )$$

(where P₃ is the third coordinate, L₁ is the distance between the first reference coordinate and the origin, L₂ is the distance between the second reference coordinate and the origin, θ is the angle formed between the first axis and the virtual line segment, and R is a predetermined ratio of the distance between the first reference coordinate and the second reference coordinate)

The third coordinate P₃, the position of which is calculated as described above, is located between the first shifted coordinates and the second shifted coordinates (400-1), as illustrated in FIG. 7.

Meanwhile, the third coordinate P₃ may have its position calculated so as to significantly improve the welding strength between the first component and the second component.

For example, the third coordinate P₃ may be calculated such that the ratio (predetermined ratio) of a predetermined distance by which the third coordinate P₃ is spaced apart from the first reference coordinate P₁ toward the second reference coordinate P₂ to the distance between the first reference coordinate P₁ and the second reference coordinate P₂ is equal to or greater than 0.2 and equal to or less than 0.7.

As another example, the third coordinate P₃ may be calculated such that the ratio (predetermined ratio) of a predetermined distance by which the third coordinate P₃ is spaced apart from the first reference coordinate P₁ toward the second reference coordinate P₂ to the distance between the first reference coordinate P₁ and the second reference coordinate P₂ is 0.5.

Hereinafter, the operation and effects of the laser irradiation positioning system for welding secondary battery components according to an embodiment of the present disclosure will be described.

The imaging portion 10 records a video of a secondary battery including a first component 100 and a second component 200 to be welded to each other and acquires image data.

Then, the identification portion 20 receives the image data acquired by the imaging portion 10 and identifies first image data relating to a video of the first component 100 and second image data relating to a video of the second component 200.

At this time, the identification portion 20 may include artificial intelligence that learns image data of secondary battery components, and may use the artificial intelligence to identify the first image data and the second image data more precisely and accurately.

Next, the conversion portion 30 converts the first image data and the second image data into a plurality of first coordinates 100-1 and a plurality of second coordinates 200-1 arranged on a virtual coordinate plane.

At this time, the conversion portion 30 may use a fast Fourier transform when converting image data into coordinates, thereby enabling the image data to be converted into coordinate data more accurately.

Next, the calculation portion 40 may calculate a position of a third coordinate P₃, at which a laser is to be irradiated, based on the plurality of first coordinates 100-1 and the plurality of second coordinates 200-1.

Specifically, the calculation portion 40 may calculate a position of the third coordinate P₃ by using a first reference coordinate P₁, which is a point where a plurality of first shifted coordinates 100-2, obtained by shifting the plurality of first coordinates 100-1, intersect with a virtual line segment I, and a second reference coordinate P₂, which is a point where a plurality of second shifted coordinates 200-2, obtained by shifting the plurality of second coordinates 200-1, intersect with the virtual line segment I.

At this time, the calculation portion 40 may calculate a distance by which the third coordinate P₃ is spaced apart from the first reference coordinate P₁ toward the second reference coordinate P₂ so that the welding strength between the first component 100 and the second component 200 to be welded to each other is significantly improved.

As described above, the laser irradiation positioning system and the laser irradiation positioning method for welding secondary battery components according to the present disclosure are configured such that artificial intelligence trained on image data related to secondary battery components identifies image data of secondary battery components to be welded to each other, thereby providing an effect of enabling accurate calculation of the positions of the secondary battery components to be welded to each other.

In addition, since the system is configured to calculate a position within the gap at which a laser is to be irradiated based on the accurately calculated positions of the secondary battery components, the laser can be irradiated through the gap, thereby providing an effect of significantly improving the welding strength between the secondary battery components.

In addition, since the welding strength between the secondary battery components can be significantly improved, the durability and performance of the secondary battery can be enhanced.

The foregoing description of the present disclosure is for illustration purposes only, and those skilled in the art to which the present disclosure pertains will understand that various modifications can be made without departing from the technical spirit or essential features of the present disclosure. Therefore, the embodiments described above should be understood as illustrative rather than restrictive in all respects. For example, each component described as a single entity may be implemented in a distributed manner, and likewise, components described as distributed may be implemented in a combined form.

The scope of the present disclosure is defined by the following claims rather than the detailed description above, and all changes or modifications derived from the meaning, scope, and equivalents of the claims should be interpreted as being included within the scope of the present disclosure.

What is claimed is:

1. A laser irradiation positioning system for welding secondary battery components, comprising:
an imaging portion configured to record a video of a secondary battery including a first component and a second component to be welded to each other, and acquire image data;
an identification portion configured to receive the image data and identify first image data relating to a video of the first component and second image data relating to a video of the second component from the image data;
a conversion portion configured to generate a virtual coordinate plane including a first axis and a second axis, convert the first image data into a plurality of first coordinates arranged on the virtual coordinate plane, and convert the second image data into a plurality of second coordinates arranged on the virtual coordinate plane; and
a calculation portion configured to calculate a position at which a laser is to be irradiated based on the plurality of first coordinates and the plurality of second coordinates.

2. The system according to claim 1, wherein the identification portion is configured to identify the first image data and the second image data by learning image data relating to components of the secondary battery including the first component and the second component.

3. The system according to claim 1,
wherein the calculation portion is configured to:
move the first axis and the second axis such that an average value of values corresponding to the first axis among the plurality of first coordinates is located at an origin with respect to the first axis, and an average value of values corresponding to the second axis among the plurality of first coordinates is located at an origin with respect to the second axis, thereby converting the plurality of first coordinates into a plurality of first shifted coordinates and converting the plurality of second coordinates into a plurality of second shifted coordinates;
calculate positions of a first reference coordinate among the plurality of first shifted coordinates and a second reference coordinate among the plurality of second shifted coordinates, the first reference coordinate being a coordinate that intersects with a virtual line extending from the origin and forming a predetermined angle with the first axis, and the second reference coordinate being a coordinate that intersects with the virtual line; and
calculate a third coordinate, at which a laser is to be irradiated, the third coordinate being located between the first reference coordinate and the second reference coordinate.

4. The system according to claim 3, wherein the predetermined angle is an angle selected in a range of 0 degrees to 360 degrees.

5. The system according to claim 4, wherein the third coordinate is located at a position spaced by a predetermined distance from the first reference coordinate toward the second reference coordinate.

6. The system according to claim 5, wherein the predetermined distance is a distance corresponding to a predetermined ratio of a distance between the first reference coordinate and the second reference coordinate.

7. The system according to claim 6, wherein the predetermined ratio is in a range of 0.2 to 0.7.

8. The system according to claim 7, wherein the position of the first reference coordinate is calculated by the following Equation 1, and the position of the second reference coordinate is calculated by the following Equation 2:
$${P}_{1} = ( {L}_{1} * cos θ , {L}_{1} * sin θ )$$
(where P₁ is the position of the first reference coordinate, L₁ is a distance between the first reference coordinate and the origin, and θ is a predetermined angle formed between the first axis and the virtual line)
$${P}_{2} = ( {L}_{2} * cos θ , {L}_{2} * sin θ )$$
(where P₂ is the position of the second reference coordinate, L₂ is a distance between the second reference coordinate and the origin, and θ is a predetermined angle formed between the first axis and the virtual line)

9. The system according to claim 8, wherein the position of the third coordinate is calculated by the following Equation 3:
$${P}_{3} = ( {L}_{1} * cos θ + ( {L}_{2} * cos θ - {L}_{1} * cos θ ) * R , {L}_{1} * sin θ + ( {L}_{2} * sin θ - {L}_{1} * sin θ ) * R ) \qquad [ Equation 3 ]$$
(where P₃ is the third coordinate, L₁ is a distance between the first reference coordinate and the origin, L₂ is a distance between the second reference coordinate and the origin, θ is an angle formed between the first axis and the virtual line, and R is a predetermined ratio of a distance between the first and second reference coordinates)

10. The system according to claim 9, wherein the predetermined ratio is 0.5.

11. A laser irradiation positioning method for welding secondary battery components, comprising:
an imaging step of recording a video of a secondary battery including a first component and a second component to be welded to each other, and acquiring image data;
an identification step of receiving the image data and identifying first image data relating to a video of the first component and second image data relating to a video of the second component from the image data;
a conversion step of generating a virtual coordinate plane including a first axis and a second axis, converting the first image data into a plurality of first coordinates arranged on the virtual coordinate plane, and converting the second image data into a plurality of second coordinates arranged on the virtual coordinate plane; and
a calculation step of calculating a position at which a laser is to be irradiated based on the plurality of first coordinates and the plurality of second coordinates.

12. The method according to claim 11,
wherein the calculation step includes:
a placement step of moving the first axis and the second axis such that an average value of values corresponding to the first axis among the plurality of first coordinates is located at an origin with respect to the first axis, and an average value of values corresponding to the second axis among the plurality of first coordinates is located at an origin with respect to the second axis, thereby converting the plurality of first coordinates into a plurality of first shifted coordinates and converting the plurality of second coordinates into a plurality of second shifted coordinates;
a first calculation step of calculating positions of a first reference coordinate among the plurality of first shifted coordinates and a second reference coordinate among the plurality of second shifted coordinates, the first reference coordinate being a coordinate that intersects with a virtual line extending from the origin and forming a predetermined angle with the first axis, and the second reference coordinate being a coordinate that intersects with the virtual line; and
a second calculation step of calculating a third coordinate, at which a laser is to be irradiated, the third coordinate being located between the first reference coordinate and the second reference coordinate.

13. The method according to claim 12, wherein the predetermined angle is an angle selected in a range of 0 degrees to 360 degrees.

14. The method according to claim 13, wherein the third coordinate is located at a position spaced by a predetermined distance from the first reference coordinate toward the second reference coordinate.

15. The method according to claim 14, wherein the predetermined distance is a distance corresponding to a predetermined ratio of a distance between the first reference coordinate and the second reference coordinate.

16. The method according to claim 15, wherein the position of the first reference coordinate is calculated by the following Equation 1, and the position of the second reference coordinate is calculated by the following Equation 2:
$${P}_{1} = ( {L}_{1} * cos θ , {L}_{1} * sin θ )$$
(where P₁ is the position of the first reference coordinate, L₁ is a distance between the first reference coordinate and the origin, and θ is a predetermined angle formed between the first axis and the virtual line)
$${P}_{2} = ( {L}_{2} * cos θ , {L}_{2} * sin θ )$$
(where P₂ is the position of the second reference coordinate, L₂ is a distance between the second reference coordinate and the origin, and θ is a predetermined angle formed between the first axis and the virtual line)

17. The method according to claim 16, wherein the position of the third coordinate is calculated by the following Equation 3:
$${P}_{3} = ( {L}_{1} * cos θ + ( {L}_{2} * cos θ - {L}_{1} * cos θ ) * R , {L}_{1} * sin θ + ( {L}_{2} * sin θ - {L}_{1} * sin θ ) * R ) \qquad [ Equation 3 ]$$
(where P₃ is the third coordinate, L₁ is a distance between the first reference coordinate and the origin, L₂ is a distance between the second reference coordinate and the origin, θ is an angle formed between the first axis and the virtual line, and R is a predetermined ratio of a distance between the first and second reference coordinates)

18. The method according to claim 17, wherein the predetermined ratio is in a range of 0.2 to 0.7.
